(19) United States
(12) Patent Application Publication
(10) Pub. No.: US 2017/0018989 A1
(43) Pub. Date: Jan. 19, 2017

(54) SEALING METHOD FOR INSULATED CONDUCTORS IN ELECTRIC SUBMERSIBLE PUMP POTHEAD CONNECTORS

(71) Applicant: GE Oil & Gas ESP, Inc., Oklahama City, OK (US)

(72) Inventors: Brian Paul REEVES, Oklahoma City, OK (US); Steven Alan HOWELL, Oklahoma City, OK (US)

(21) Appl. No.: 15/105,097

(22) PCT Filed: Dec. 16, 2013
(86) PCT No.: PCT/US2013/075476

§ 371 Date: Jun. 16, 2016

(51) Int. Cl. H02K 5/132; F04C 2/16; F04C 15/00; H01R 13/52; E21B 17/20; H01B 7/20; H02K 5/22; F04D 13/08; E21B 43/12

(52) U.S. Cl. CPC H02K 5/132; F04D 13/086; F04C 2/16; F04C 15/008; E21B 43/128; E21B 17/206; H01B 7/20; H02K 5/225; H01R 13/5205; F04C 2240/40

(57) ABSTRACT

An electric submersible pumping system includes an electric motor and a motor lead cable. The motor lead cable includes a plurality of leads that each includes a conductor, an insulator and a sealing sleeve around the insulator. The sealing sleeve is constructed of metal in preferred embodiments. The electric submersible pumping system further includes a pothead connector attached to the electric motor and the motor lead cable. The pothead connector includes a sealing mechanism around the metal sleeve of each of the plurality of leads.

### FIELD OF THE INVENTION

This invention relates generally to the field of electric submersible pumping systems, and more particularly, but not by way of limitation, to a method and apparatus for sealing an insulated electrical connector.

### BACKGROUND

Electrical submersible pumping systems include specialized electric motors that are used to power one or more high performance pump assemblies. The motor is typically an oil-filled, high capacity electric motor that can vary greatly in length and may be rated up to hundreds of horsepower. The electrical submersible pumping systems are often subjected to high-temperature, corrosive environments. Each component within the electrical submersible pump must be designed and manufactured to withstand these hostile conditions.

Typically, electricity is generated on the surface and supplied to the motor through a heavy-duty power cable. The power cable typically includes several separate conductors that are individually insulated within the power cable. Power cables are often constructed in round or flat configurations. In many applications, power is conducted from the power cable to the motor via a “motor lead cable.” The motor lead cable typically includes one or more “leads” that are configured for connection to a mating receptacle on the motor. The leads from the motor lead cable are often retained within a motor-connector that is commonly referred to as a “pothead.” The pothead relieves the stress or strain realized between the motor and the leads from the motor lead cable. Motor lead cable is often constructed in a “flat” configuration for use in the limited space between downhole equipment and the well casing.

Because the power and motor lead cables are positioned in the annulus between the production string and well casing, these cables and connectors must be designed to withstand the inhospitable downhole environment. Power and motor lead cables typically include a conductor, insulation surrounding the conductor, a sheath encasing the insulation and a durable external armor that surrounds the sheath. Although covered by several layers of protection, the insulation remains a common source of failure in power and motor lead cables. In the past, manufacturers have used EPDM rubber, polypropylene or polyethylene as the dielectric insulation layer that surrounds the conductive material.

In the prior art, the potheads and other connectors are sealed around the insulated power cables through use of elastomeric block or O-ring seals that are compressed directly against the insulator. These elastomeric blocks are prone to failure for a number of different reasons, including thermal stresses due to expansion and contraction, explosive decompression, and entrapped air. Elastomeric O-ring seals manufactured from the same materials as the insulation around the conductor may be unable to accommodate the swell of the insulator due to thermal expansion or absorption of hydrocarbons. It is to this and other deficiencies in the prior art that the present invention is directed.

### SUMMARY OF THE INVENTION

In a preferred embodiment, an electric submersible pumping system includes an electric motor and a motor lead cable. The motor lead cable includes a plurality of leads that each includes a conductor, an insulator and a sealing sleeve around the insulator. The sealing sleeve is constructed of metal in preferred embodiments. The electric submersible pumping system further includes a pothead connector attached to the electric motor and the motor lead cable. The pothead connector includes a sealing mechanism around the metal sleeve of each of the plurality of leads.

In another aspect, the preferred embodiments include a motor lead cable configured for connection to a pothead connector. The motor lead cable includes a plurality of leads that each includes a conductor, an insulator, and a sealing sleeve around the insulator. The sealing sleeve is preferably constructed of metal. The motor lead cable also includes external armor surrounding the plurality of leads.

In yet another aspect, the preferred embodiments include an apparatus for providing a seal around an electric lead having a conductor and an insulator surrounding the conductor. The apparatus preferably includes a sealing sleeve around the insulator and a sealing mechanism around the sealing sleeve. The sealing sleeve is preferably manufactured from metal.

### BRIEF DESCRIPTION OF THE DRAWINGS

FIG. 1 is a perspective view of an electric submersible pumping system constructed in accordance with a preferred embodiment.

FIG. 2 is a perspective view of a motor lead cable with the leads exposed and stripped.

FIG. 3 is a cross-sectional view of the leads and insulators of the motor lead cable of FIG. 2.

FIG. 4 is a perspective view of the motor lead cable connected to a pothead connector.

FIG. 5 is a cross-sectional view of a first preferred embodiment for sealing the motor lead within the pothead connector.

FIG. 6 is a cross-sectional view of a second preferred embodiment for sealing the motor lead within the pothead connector.

FIG. 7 is a cross-sectional view of a third preferred embodiment for sealing the motor lead within the pothead connector.

FIG. 8 is a cross-sectional view of a fourth preferred embodiment for sealing the motor lead within a sealing block.

### DETAILED DESCRIPTION OF THE PREFERRED EMBODIMENTS

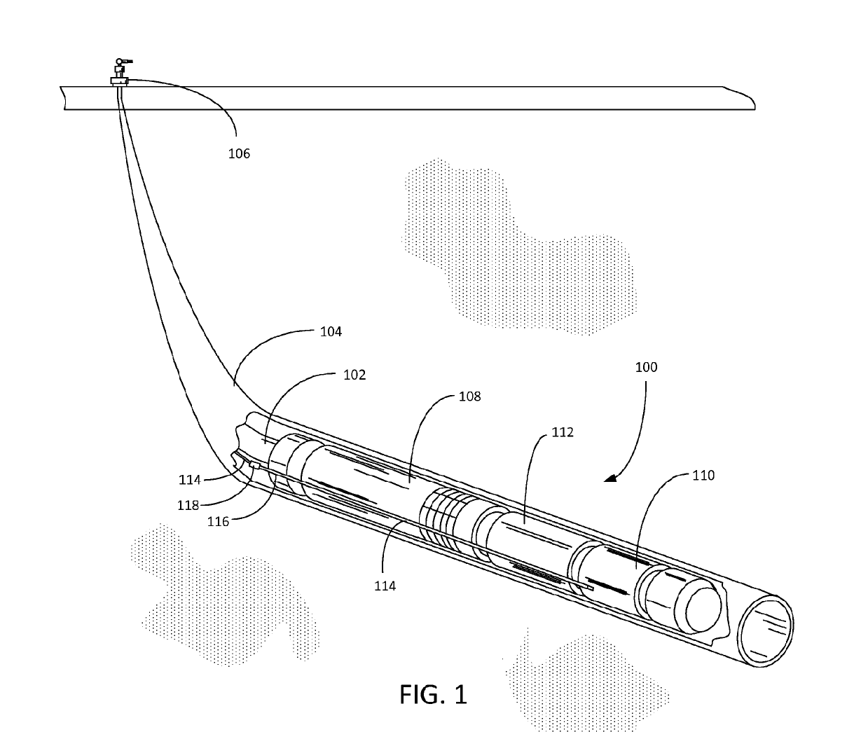

In accordance with a preferred embodiment of the present invention, FIG. 1 shows a front perspective view of a downhole pumping system 100 attached to production tubing 102. The downhole pumping system 100 and production tubing 102 are disposed in a wellbore 104, which is drilled for the production of a fluid such as water or petroleum. The downhole pumping system 100 is shown in a non-vertical well. This type of well is often referred to as a “horizontal” well. Although the downhole pumping system 100 is depicted in a horizontal well, it will be appreciated that the downhole pumping system 100 can also be used in vertical, deviated and other non-horizontal wells.

As used herein, the term “petroleum” refers broadly to all mineral hydrocarbons, such as crude oil, gas and combinations of oil and gas. The production tubing 102 connects the pumping system 100 to a wellhead 106 located on the surface. Although the pumping system 100 is primarily designed to pump petroleum products, it will be understood that the present invention can also be used to move other fluids. It will also be understood that, although each of the components of the pumping system 100 are primarily disclosed in a submersible application, some or all of these components can also be used in surface pumping operations.

The pumping system 100 preferably includes some combination of a pump assembly 108, a motor assembly 110 and a seal section 112. The motor assembly 110 converts the electrical energy into mechanical energy, which is transmitted to the pump assembly 108 by one or more shafts. The pump assembly 108 then transfers a portion of this mechanical energy to fluids within the wellbore, causing the wellbore fluids to move through the production tubing to the surface. In a particularly preferred embodiment, the pump assembly 108 is a turbomachine that uses one or more impellers and diffusers to convert mechanical energy into pressure head. In an alternative embodiment, the pump assembly 108 is a progressive cavity (PC) or positive displacement pump that moves wellbore fluids with one or more screws or pistons.

The seal section 112 shields the motor assembly 110 from mechanical thrust produced by the pump assembly 108. The seal section 112 is also preferably configured to prevent the introduction of contaminants from the wellbore 104 into the motor assembly 110. Although only one pump assembly 108, seal section 112 and motor assembly 110 are shown, it will be understood that the downhole pumping system 100 could include additional pumps assemblies 108, seals sections 112 or motor assemblies 110.

The pumping system 100 preferably includes a power cable 114, a motor lead cable 116 and a cable connector 118. The power cable 114, motor lead cable 116 and cable connector cooperate to deliver electricity to the motor assembly 110. In particularly preferred embodiments, the motor lead cable 116 includes additional armor and a low, flattened profile to more easily fit within the limited annular space between the wellbore 104 and the components of the pumping system 100. The power cable 114 can have a larger cross-section because it resides in the larger annular space between the production tubing 102 and the wellbore 104.

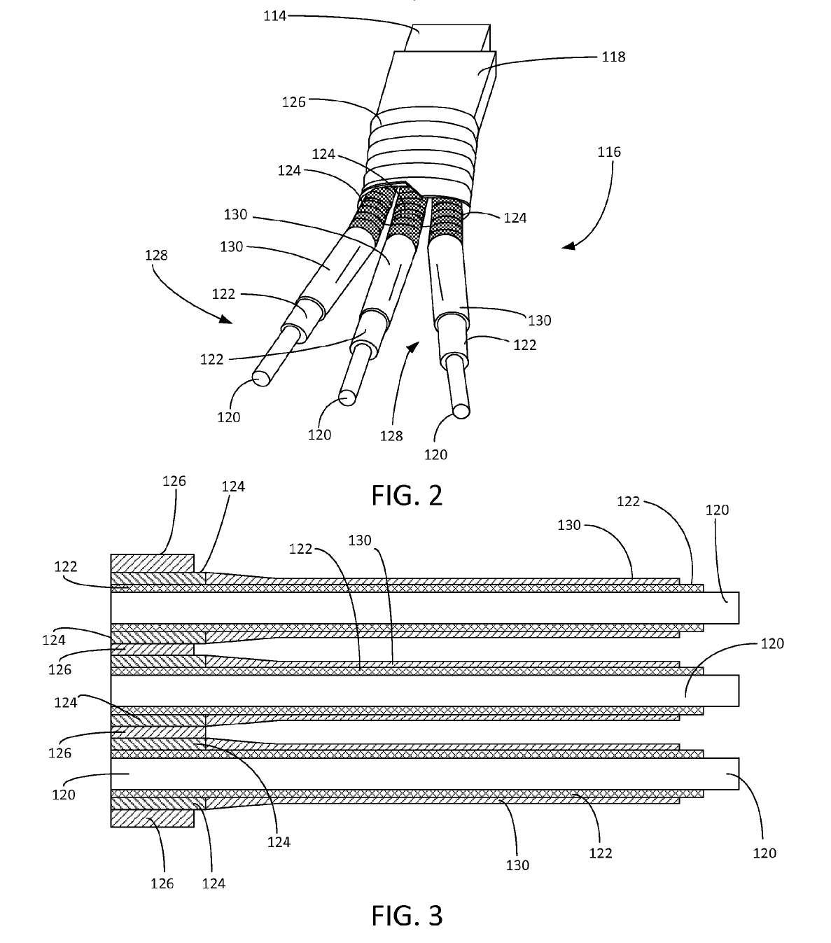

Turning to FIGS. 2 and 3, shown therein are perspective and cross-sectional views, respectively, of the motor lead cable 116 and cable connector 118. The motor lead cable 116 includes power cable conductors 120, power cable insulators 122, a sheath 124 and external armor 126. The power cable conductors 120, power cable insulators 122, and sheath 124 within the motor lead cable 116 collectively form a lead 128.

The power cable conductors 120 are preferably manufactured from copper wire or other suitable metal. The power cable conductors 120 can include a solid core (as shown in FIG. 2), a stranded core or a stranded exterior surrounding a solid core (not shown in FIG. 3). The power cable conductors 120 can also be coated with one or more layers of tin, nickel, silver, polyimide film or other suitable material. It will be understood that the size, design and composition of the power cable conductors 120 can vary depending on the requirements of the particular downhole application.

The power cable insulators 122 preferably include at least one layer of a heat-bonding type polymer film. In a particularly preferred embodiment, the power cable insulators 122 are manufactured from a biphenyl-tetracarboxylic acid dianhydride (BPDA) type polyimide film that permits heat bonding without the use of an intervening adhesive layer. Suitable polyimide films are available from UBE Industries, Ltd. under the “UPILEX VT” line of products. The polyimide film power cable insulator 122 can be heat laminated directly to the conductor 120 without the use of an adhesive.

The power cable insulators 122 are optionally encased within a sheath 124. In the preferred embodiment, the sheath 124 is constructed one or more layers of lead, nitrile, EPDM or thermoplastic, or some combination of these materials. The sheath 124 is protected from external contact by the armor 126. In the preferred embodiment, the armor 126 is manufactured from galvanized steel, stainless steel, Monel or other suitable metal or composite. The armor 126 can be configured in flat and round profiles in accordance with the flat or round configuration of the motor lead cable 116.

The motor lead cable 116 also includes a sealing sleeve 130 around each of the insulators 122. The sleeve 130 is preferably manufactured from a metal tube with an interior diameter nominally the same size, or slightly larger, than the outer diameter of the insulators 122. The sleeve 130 can be manufactured from stainless steel, galvanized steel or similar alloys. The sleeve 130 provides a relatively rigid outer surface that facilitates the establishment of a seal around the leads 128 of the motor lead cable 116. In preferred embodiments, the sleeve 130 and insulator 122 are joined for a length that is sufficient to create an impermeable seal between the insulator 122 and sleeve 130. As illustrated in FIG. 3, the sleeve 130 is preferably pressed into place on the insulator 122 along substantially the entire length of the sleeve 130.

In a first preferred embodiment, the sleeve 130 is secured to a selected portion of each lead 128 by sliding the sleeve 130 over the insulator 122 and swaging the sleeve into a compressed state over the insulator 122. In a particularly preferred embodiment, the sleeve 130 and lead 128 are passed through a die that compresses the sleeve 130 onto the insulator 122. Alternatively, a roller swaging method can be used to fix the sleeve 130 onto the insulator 122.

In a second preferred embodiment, the sleeve 130 is secured to the insulator 122 with an adhesive. The adhesive can be applied to the exterior of the insulator 122 or the interior of the sleeve 130 before the sleeve 130 is placed over the insulator 122. Alternatively, the sleeve 130 can be placed over the insulator 122 first and the adhesive can then be pumped or injected into the small space between the sleeve 130 and the insulator 122.

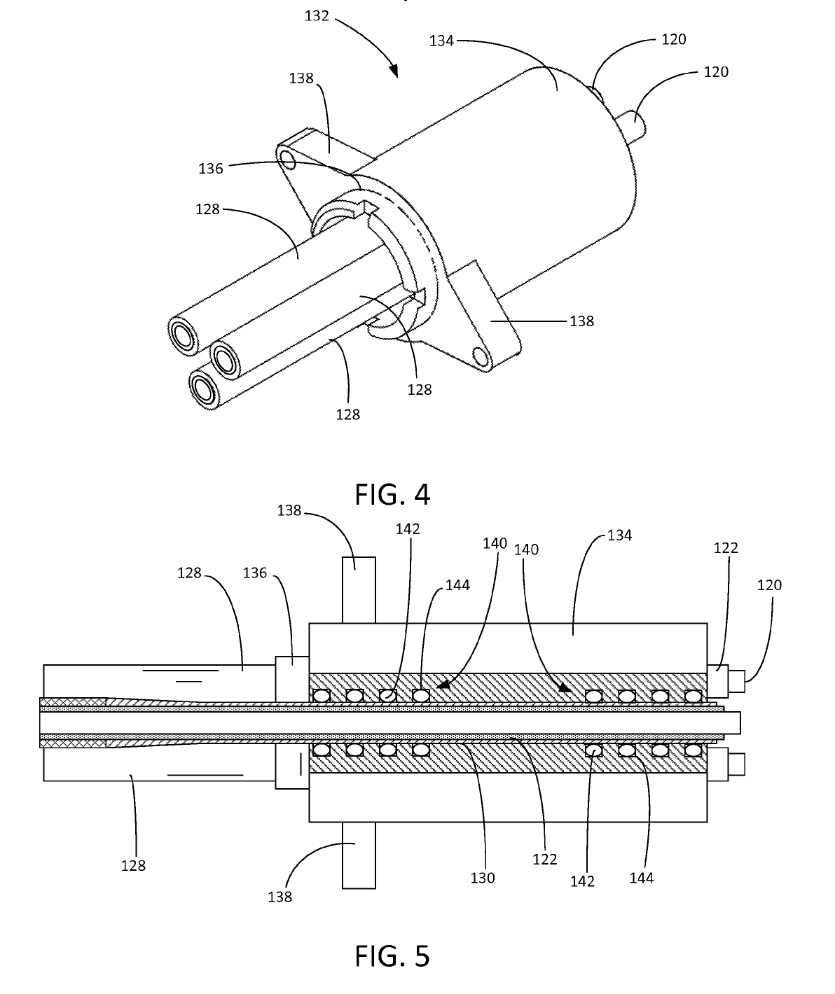

Turning to FIGS. 4 and 5, shown therein are perspective and partial cross-sectional views, respectively, of a pothead connector 132 and the leads 128 from the motor lead cable 116. It will be appreciated that the pothead connector 132 provides a strain-relieved connection between the motor lead cable 116 and the motor assembly 110. The pothead connector 132 includes a body 134, a locking collar 136 and connection flanges 138. As noted in FIG. 5, the pothead connector 132 further includes a sealing mechanism 140 that prevents migration of fluids along the leads 128. In the preferred embodiment depicted in FIG. 5, the sealing mechanism 140 includes a series of O-ring seals 142 located in seal grooves 144. The O-ring seals 142 press against the exterior surface of the sleeve 130. Because the sleeve 130 has a relatively rigid exterior surface, the sealing performance of the O-ring seals 142 is enhanced.

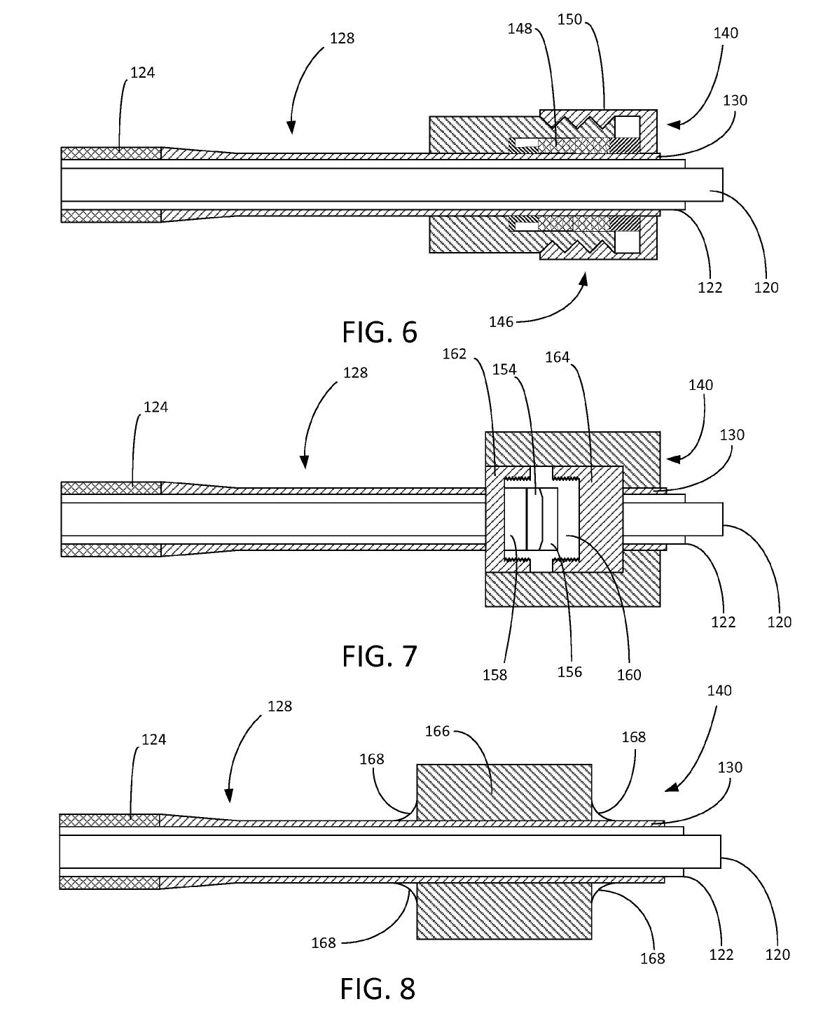

Turning to FIG. 6, shown therein is an alternate sealing mechanism 140 that includes a packing gland 146. The packing gland 146 includes packing 148 and a compression nut 150. By tightening the compression nut 150, the packing 148 can be compressed into a sealing engagement against the sleeve 130.

Turning to FIG. 7, shown therein is yet another alternate sealing mechanism that includes a compression fitting 152. The compression fitting includes a compression seal 154, a seat 156, a follower 158, a threaded housing 160, a rear nut 162 and a front nut 164. The seat 156 resides in the threaded housing 160 and provides a base for the compression seal 154. The compression seal 154 can be pushed into the seat 156 by tightening the front nut 164 to force the follower 158 into the compression seal 154. By applying pressure, the seal 154 is pressed against the sleeve 130 to form a seal around the lead 128 through the sealing mechanism 140.

Turning to FIG. 8, shown therein is yet another alternate mechanism for sealing the lead 128 to a sealing block 166. The sealing block 166 is manufactured out of metal. The sealing block 166 may be used in a number of applications, including as a pothead connector. As depicted in FIG. 8, the sleeve 130 is fixed to the insulator 122. The sleeve 130 is then passed through the sealing block 166. The sleeve 130 is then welded or brazed to the sealing block 160 using conventional techniques to create joined seals 168. The joined seals 168 create a durable seal between the leads 128 and the sealing block 166.

Thus, the use of the sleeve 130 within each of the leads 128 provides an advantageous means for providing a seal around the lead 128. Although the preferred embodiments have been described with reference to sealing mechanisms 140 and a pothead connector 132, it will be appreciated that the use of the sleeve 130 will find utility in additional applications. For example, the sleeve 130 can be used to provide a sealing surface for use in the cable connector 118 between the leads in the power cable 114 and the leads 128 in the motor lead cable 116.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. A motor lead cable configured for connection to a pothead connector, the motor lead cable comprising:
a plurality of leads, wherein each of the plurality of leads comprises:
a conductor;
an insulator; and
a sealing sleeve around the insulator; wherein the sealing sleeve is constructed of metal.

2. The motor lead cable of claim 1, wherein the sealing sleeve is swaged into attachment with the insulator and wherein each of the plurality of leads is connected to a common sealing mechanism.

3. The motor lead cable of claim 1, wherein the sealing device is secured to the insulator with an adhesive.

4. An electric submersible pumping system comprising:
an electric motor;
a motor lead cable, wherein the motor lead cable comprises a plurality of leads and wherein each of the plurality of leads comprises:
a conductor;
an insulator; and
a sealing sleeve around the insulator; wherein the sealing sleeve is constructed of metal; and
a pothead connector attached to the electric motor and the motor lead cable, wherein the pothead connector comprises a sealing mechanism around the metal sleeve of each of the plurality of leads.

5. The electric submersible pumping system of claim 4, wherein the sealing sleeve is substantially inflexible.

6. The electric submersible pumping system of claim 4, wherein the sealing mechanism comprises:
one or more seal grooves; and
an O-ring seal in each of the one or more seal grooves, wherein each of the O-ring seals is in sealing contact with the sleeve of a respective one of the plurality of leads.

7. The electric submersible pumping system of claim 4, wherein the sealing mechanism comprises:
packing around each of the metal sleeves of the plurality of leads; and
a compression nut that compresses the packing around the metal sleeves.

8. The electric submersible pumping system of claim 4, wherein the sealing mechanism comprises a compression fitting, wherein the compression fitting comprises:
a seal surrounding the each of the metal sleeves of the plurality of leads;
a seat configured to support the seal; and
a follower configured to press the seal into the seat.

9. The electric submersible pumping system of claim 4, wherein each of the metal sleeves of the plurality of leads is welded to the pothead connector.

10. An apparatus for providing a seal around an electric lead having a conductor and an insulator surrounding the conductor, the apparatus comprising:
a sealing sleeve around the insulator; wherein the sealing sleeve is constructed of metal; and
a sealing mechanism around the sealing sleeve.

11. The apparatus of claim 10, wherein the sealing sleeve is substantially inflexible.

12. The apparatus of claim 10, wherein the sealing mechanism comprises:
one or more seal grooves; and
an O-ring seal in each of the one or more seal grooves, wherein each of the O-ring seals is in sealing contact with the sleeve of the plurality of leads.

13. The apparatus of claim 10, wherein the sealing mechanism comprises:
packing around the metal sleeve; and
a compression nut that compresses the packing around the metal sleeve.

14. The apparatus of claim 10, wherein the sealing mechanism comprises a compression fitting, wherein the compression fitting comprises:
a seal surrounding the metal sleeve;
a seat configured to support the seal; and
a follower configured to press the seal into the seat.

15. The apparatus of claim 10, wherein the sleeve is swaged into contact with the insulator.

16. The apparatus of claim 10, wherein the sleeve is connected to the insulator with an adhesive.

17. The apparatus of claim 10, wherein the sleeve is welded to the sealing mechanism.

18. The apparatus of claim 10, wherein the sleeve is brazed to the sealing mechanism.
